(19) United States
(12) Patent Application Publication
(10) Pub. No.: US 2024/0192881 A1
(43) Pub. Date: Jun. 13, 2024

(54) Overprovisioning Block Mapping for Namespace

(71) Applicant: PetaIO Inc., Santa Clara, CA (US)

(72) Inventors: Jongman Yoon, San Jose, CA (US); Huaitao Wang, Shanghai (CN)

(21) Appl. No.: 18/078,364

(22) Filed: Dec. 9, 2022

(51) Int. Cl. G06F 3/06; G06F 12/10

(52) U.S. Cl. CPC G06F 3/0644; G06F 3/0604; G06F 3/0673; G06F 12/10

(57) ABSTRACT

A namespace is a declarative region that provides a scope to identifiers inside the namespace, which identifiers are the names of types, functions, variables, and the like. Namespaces are used to organize code into logical groups. A namespace is a collection of logical block addresses that are accessible to host software. The logical block addresses that comprise a namespace may be utilized to minimize overhead with smaller allocation of resources for multiple namespaces in SSD and to improve the operation of the OS by eliminating the need for defragmentation operations.

### BACKGROUND

### Field of the Invention

This invention relates to systems and methods for managing namespaces and fragmentation using overprovisioning block mapping.

### Background of the Invention

A namespace (NS) may be described as a declarative region that provides a scope to the identifiers inside the namespace. The identifiers can include the names of types, functions, variables, etc. Namespaces may be used to organize code into logical groups and to prevent name collisions that can occur, especially when a code base includes multiple libraries. Namespaces provide a means by which name conflicts in large projects can be prevented. A namespace can be used as additional information to differentiate similar functions, classes, variables, etc.

In NVMe™ technology, a namespace is a collection of logical block addresses (LBA) accessible to host software. A namespace that may be defined in NVMe™ specification is a collection of logical block addresses that range from 0 to the size of the namespace. A namespace of size n consists of LBA 0 through (n −1).

A namespace is a similar concept to the partitioning of a hard disk drive in an operating system (OS). A namespace can be allocated and unallocated dynamically by a host NVMe™ command set that is to slice one or more regions of the user data volume of NVMe™ solid-state drive (SSD).

In the very initial stages, every namespace can get allocation of a single, whole chunk of logical blocks from a NVMe™ SSD. Eventually, the namespace may end up with many fragmented regions due to continuous allocation and deallocation of multiple namespaces. The file system of an OS may take care of this fragmentation issue by relocating data to be to be linked in continuous LBA, which is called defragmentation, or using a scatter/gather list, or a lookup table to concatenate two or more discontinuous LBA regions. However, this type of approach can lead to substantial overhead and may decrease performance of the OS.

It would be an advancement in the art to minimize overhead with smaller allocation of resources for multiple namespaces in SSD. It would also be an advancement in the art to improve the operation of the OS by eliminating the need for defragmentation operations.

In a storage context, overprovisioning may be described as the inclusion of extra storage capacity in a solid-state drive. This overprovisioning can increase the endurance of a SSD by distributing the total number of writes and erases across a larger population of NAND flash memory blocks and pages over time. SSD overprovisioning also provides the flash controller additional buffer space for managing program/erase cycles. The additional buffer space can improve overall SSD performance.

There are three types of overprovisioning: inherent, vendor-configured, and user-configured. Inherent overprovisioning is reserved for the overhead that comes with normal P/E cycles and operations. Vendor-configured overprovisioning is when a SSD manufacturer sets aside additional capacity to accommodate write-intensive workloads. Inherent and vendor-configured overprovisioning is not available to the host. User-configured overprovisioning comes out of the unreserved user capacity and may utilized or configured in accordance with the user's desires.

It would be an advancement in the art to provide a method for overprovisioning block mapping of namespaces in a manner that improves the performance of the SSD and eliminates the need for defragmentation operations.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a computing system suitable for implementing an approach in accordance with embodiments of the invention;

FIG. 2 is a schematic block diagram illustrating a process for managing namespaces;

FIG. 3 is schematic block diagram illustrating a process for overprovisioning in accordance with the prior art;

FIG. 4 is a schematic block diagram illustrating a process for overprovisioning block mapping in accordance with an embodiment of the present invention;

FIG. 5 is a schematic block diagram illustrating a process for block mapping in accordance with an embodiment of the present invention;

FIG. 6 is a schematic block diagram illustrating a process for block mapping in accordance with an embodiment of the present invention;

FIG. 7 is a flow diagram illustrating the positioning of the block mapping process; and

FIG. 8 is a schematic block diagram illustrating a process for overprovisioning block mapping in accordance with an embodiment of the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

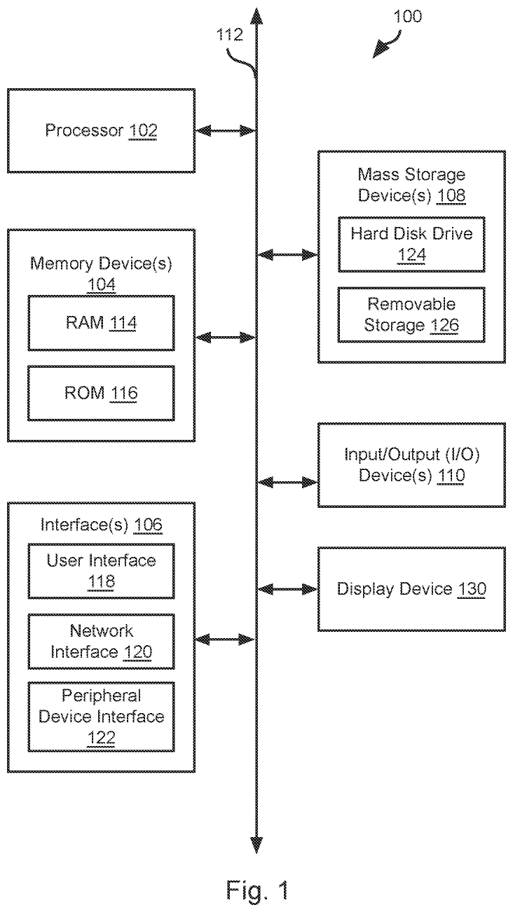

FIG. 1 is a block diagram illustrating an example computing device 100. Computing device 100 may be used to perform various procedures, such as those discussed herein. Computing device 100 can function as a server, a client, or any other computing entity. Computing device 100 can be any of a wide variety of computing devices, such as a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (RAM) 114) and/or nonvolatile memory (e.g., read-only memory (ROM) 116). memory device(s) 104 may also include rewritable ROM, such as flash memory.

Mass storage device(s) 108 include various computer readable media, such as magnetic tapes, magnetic disks, optical disks, solid-state memory (e.g., flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, lenses, CCDs or other image capture devices, and the like.

Display device 130 includes any type of device capable of displaying information to one or more users of computing device 100. Examples of display device 130 include a monitor, display terminal, video projection device, and the like.

interface(s) 106 include various interfaces that allow computing device 100 to interact with other systems, devices, or computing environments. Example interface(s) 106 include any number of different network interfaces 120, such as interfaces to local area networks (LANs), wide area networks (WANs), wireless networks, and the Internet. Other interface(s) include user interface 118 and peripheral device interface 122. The interface(s) 106 may also include one or more user interface elements 118. The interface(s) 106 may also include one or more peripheral interfaces such as interfaces for printers, pointing devices (mice, track pad, etc.), keyboards, and the like.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 100, and are executed by processor(s) 102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

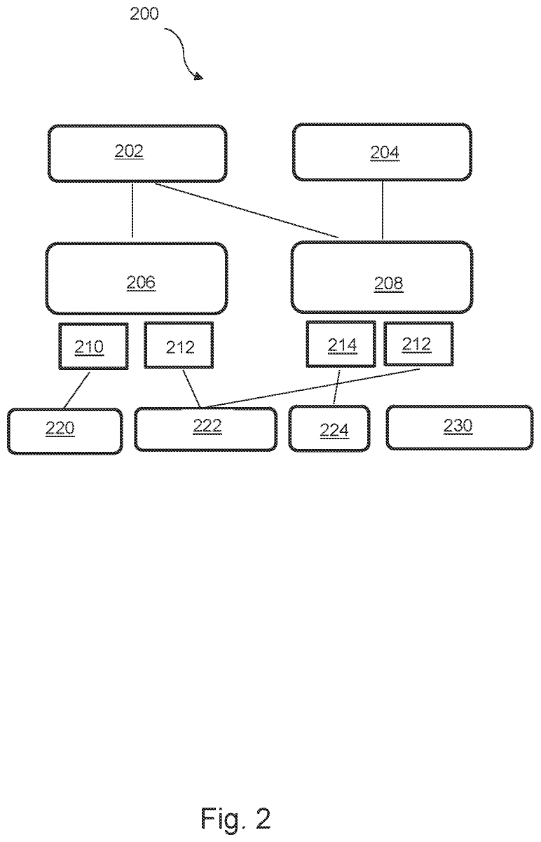

Referring to FIG. 2, a process for managing namespaces 200 may be configured in any suitable manner. For example, an SSD controller 206, 208 may receive read and write instructions from a host interface 202, 204 implemented on or for a host device, such as a device including some or all of the attributes of the computing device 100. The host interface 202 may be a data bus, memory controller, or other components of an input/output system of a computing device, such as the computing device 100 of FIG. 1. A typical controller 206, or multiple controllers (206 and 208), may use multiple namespace identifiers (210, 212 and 214) corresponding to multiple namespaces (220, 222 and 224). Via a namespace identifier 210, a namespace 220 may be attached to a controller 206 in a manner that may be described as a private attachment. The same namespace identifier 212 may be used by multiple controllers 206, 208 thereby attaching one namespace 222 to multiple controllers in a manner that may be described as a shared attachment. A collection of namespaces may also include an unallocated portion of non-volatile memory 230.

In NVMe™ specifications, a limit may be put on the maximum number of namespaces to be allocated at once, while still allowing the namespaces to be dynamically allocated and deallocated continuously. This ability to allow for the continuous allocation and deallocation of namespaces may make the management of the defragmentation operation easier for the SSD.

The methods described below may be performed by the SSD controller 206, the host interface 202, or a combination of the two. The methods described herein may be executed by any component in such a storage device or be performed completely or partially by a host processor coupled to the storage device.

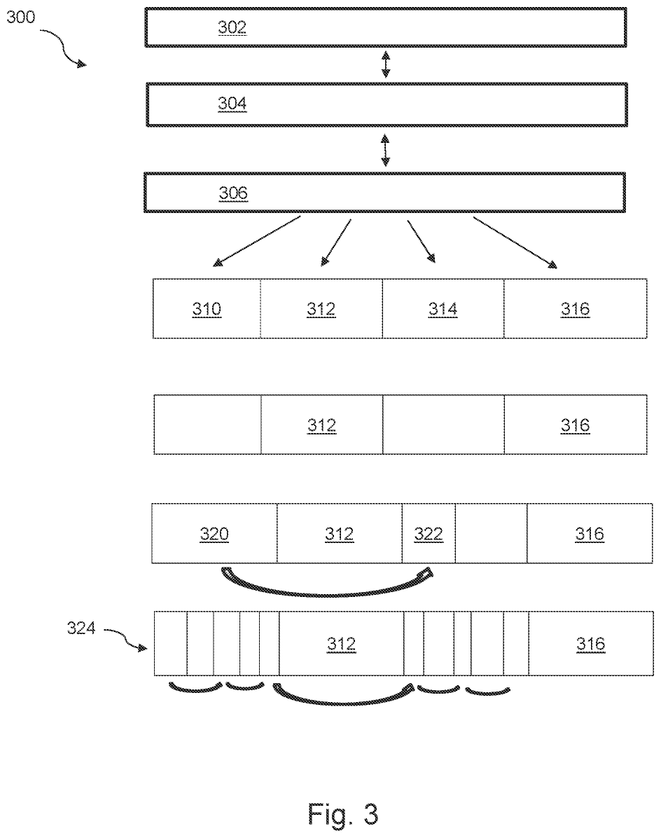

FIG. 3 is a diagram showing a typical, conventional process for overprovisioning 300. A solid-state drive 302 may be described as having a physical capacity and an LBA range, i.e., a capacity range of 0˜9,999. Similarly, a solid-state drive 304 may be described as having a L2P mapping (Logical Drive LBA to Physical NAND address) LBA range, i.e., an L2P mapping range of 0˜9,999. A solid-state drive may include a LBA to Namespace mapping linked list 306.

Multiple namespaces (310, 312, 314 and 316) may be created and then mapped to the SSD LBA. For example, each namespace 310, 312, 314 and 316 may be created with a LBA range of 2,500. Namespace 310 may be mapped to SSD LBA 0˜2,499. Namespace 312 may be mapped to SSD LBA 2,500˜4,999. Namespace 314 may be mapped to SSD LBA 5,000˜7,499. Namespace 316 may be mapped to SSD LBA 7,500˜9,999.

Namespaces 310 and 314 may then be deleted. Namespaces 312 and 316 may be kept.

A namespace may be created again with a namespace LBA range of 3,090, including two fragments. The namespace may have a first fragment 320 corresponding to an original namespace 310 with an LBA range of 0˜2,499 and mapped to SSD LBA 0˜2,499, and a second fragment 322 with an LBA range of 2,500˜3,099 and mapped to SSD LBA 5,000˜5,589.

Namespaces may be deleted and re-created continuously with different LBA ranges and mapped to different fragments 324. Using the linked list 306, it can concatenate multiple fragmentations.

Usually, an operating system will manage namespaces in this way. However, as namespaces are continuously kept, deleted and created with different LBA ranges, more fragmentations for each namespace will be produced. This will make the management of namespaces increasingly complicated. It will also necessitate a defragmentation process.

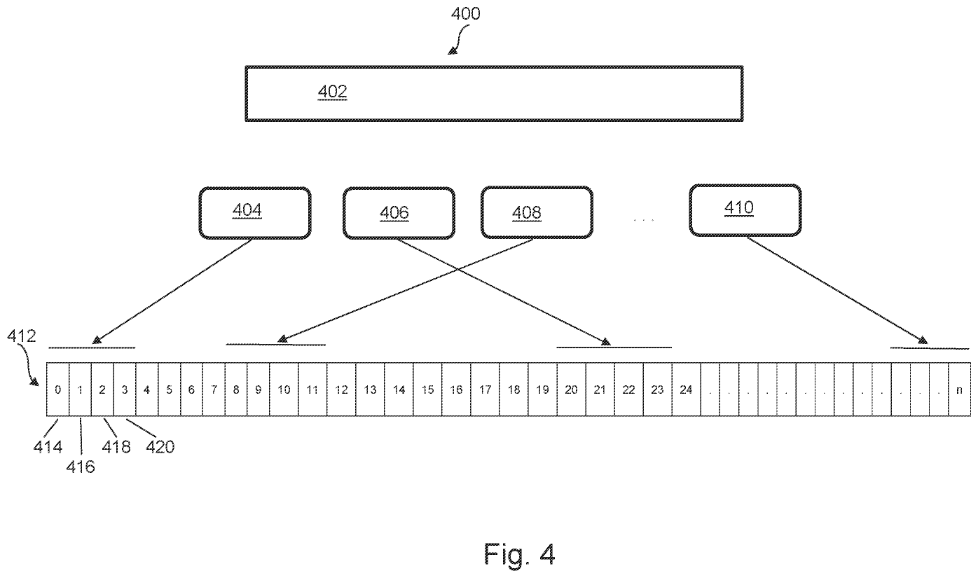

FIG. 4 is a schematic block diagram illustrating one embodiment of a process for overprovisioning block mapping 400. This process may include a namespace 402 comprising multiple blocks, or logical block addresses, 404, 406, 408 and 410. A SSD may include an array of consecutive LBA ranges with a fixed length and starting LBA, 412. For example, the whole range of LBA of one NVMe™ SSD can be divided by the fixed LBA length 0x 10_000. Block 0 starts with 0x 00 LBA and 0x 10_000 length, 414. Block 1 starts with 0x 10_000 LBA and 0x 10_000 length, 416. Block 2 with 0x 20_000 LBA and 0x 10_000, 418, and so on.

A host LBA, or LBA of a namespace, 404 may be associated with a portion of the drive LBA, 412. For example, LBA 404 may be associated with blocks 0, 1, 2 and 3 (illustrated as 414, 416, 418 and 420). Similarly, host LBA 406 may be associated with a portion of the drive LBA 412, i.e., LBA 406 may be associated with blocks 20, 21, 22 and 23. Similarly, host LBA 408 may be associated with a portion of the drive LBA 412, i.e., LBA 408 may be associated with blocks 8, 9, 10 and 11. This process may be repeated for any number of host LBA and associated portions of the drive LBA 412, i.e., LBA 410 may associated with appropriate blocks in the LBA drive.

Determining the association between Host LBA (LBA of a namespace) and Drive LBA (LBA of user data volume of SSD) is a key item in SSD management, especially as to fragmentation management necessitated by the operation of multiple-namespaces. For such fragmentation management, the scatter/gather list could be used but it may not be ideal for high-performance SSD because the complexity of fragmentation management may cause additional CPU overhead.

Block mapping may be inserted under the namespace of NVMe™ protocol and above L2P mapping (Logical Drive LBA to Physical NAND address) table of FTL in SSD.

A two-level mapping table may be established. The first level mapping is a block mapping. The second level mapping is a L2P mapping. The two-level mapping, the association from the Host LBA all the way down to the Physical NAND address can be defined. The following is an example of how to convert the Host LBA to a Physical NAND address.

Level 1: Host LBA to Drive LBA through Block Mapping Table
1. Block #=Host LBA/Block Size
2. The starting LBA of Block=>Look up the Block Mapping with Block #
3. LBA Offset=Host LBA % Block Size
4. Target Drive LBA=the starting LBA of Block+LBA Offset

Level 2: Target Drive LBA to Physical NAND address
1. Look up the L2P mapping table with the Target Drive LBA
2. Find the Physical NAND address corresponding to Host LBA

The following is an example of the structure of Block Mapping.

The number of blocks needed for Block Mapping to cover user data LBA range of SSD can be calculated using the following equation:

# of Blocks for SSD volume=round-up{(total LBA range of SSD+1)/block_size}

The block allocations for a namespace may be determined as described herein. When it comes to a new namespace allocation request, it should allocate many blocks from the free resource pool corresponding to the LBA range of that namespace. However, it needs a round-up operation like that described herein above. Some of the LBA of the last block allocated to that namespace may have leftover LBA due to the round-up operation. How to deal with the leftover of the LBA range of the last block is a key item to avoid the overhead of fragmentation management.

The leftover LBA range may be wasted, or not used. However, more spare blocks will be required beyond the number of total user data blocks. The portion of the leftover LBA range that is wasted can be controlled by the programmer, and may be any appropriate proportion. The leftover LBA of the last allocated block can vary from 0˜m−1, where m equals the total LBA size of the last allocated block. For example, one-half of the LBA range of the last allocated block may be leftover and wasted, but any appropriate portion may be designated.

The spare data blocks required may be calculated in the following manner. The number of spare blocks needed can be determined by the number of namespaces supported in the SSD. For example, n is the number of max NS and then if n is ‘1’, the number of spare blocks is ‘0’. If n is ‘2’, the number of spare blocks is ‘1’, and so on. This can be described with the following equation:

# of spare blocks=n−1

In the internal operation of SSD, it needs to enlarge the addressable LBA range of SSD bigger than the actual user data LBA range of the SSD to cover the spare blocks.

The bigger addressable LBA range due to additional Spare Data Blocks requires FTL to manage the bigger L2P (Logical LBA to Physical NAND address) mapping table than the actual L2P mapping table to cover the actual volume of LBA range of SSD. But the invention described herein does not require physical NAND space to store additional data, because the leftover LBA range of the last block mapped to a certain namespace is never to be valid, which means that it will never be used, just wasted. So, the total valid LBA range of overprovisioning block mapping, even with additional spare blocks is exactly the same as the actual LBA range of SSD. The address LBA range is enlarged to cover additional Spare Data Blocks, but the valid LBA range over the addressable LBA mapping is to be contained in the same as the actual LBA range of the SSD volume.

Thus, this system eliminates the need to manage the fragmentation of SSD volume, even with dynamic multiple namespace allocation and deallocation. However, the only cost is to have a bigger mapping table corresponding to the additional spare blocks without additional NAND space.

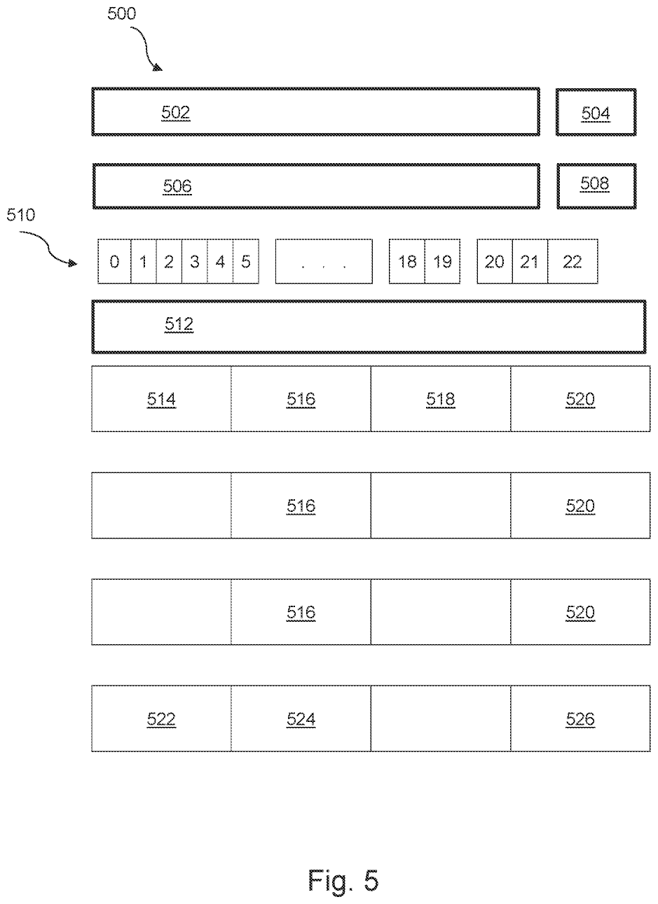

FIG. 5 is a schematic block diagram illustrating a block mapping process 500, in accordance with one embodiment of the invention. A solid-state drive 502 may be described as having a physical capacity and an LBA range, i.e., a capacity range of 0 ˜9,999, which SSD may also include a spare physical capacity 504 having a range of 10,000˜11,499. Similarly, a solid-state drive 506 may be described as having a L2P mapping (Logical Drive LBA to Physical NAND address) LBA range, i.e., an L2P mapping range of 0 ˜ 9,999, which SSD may also include a spare mapping range of 10,000˜11,499. The SSD mapping range may also be described as an array of blocks, which blocks may be designated using a numerical range, i.e., 0 to n.

For example, an array of blocks 510 may designated using a numerical range of 0 to 22, which array of blocks is associated with four namespaces. One block size may have an LBA range of 500. A desired number of extra blocks may be determined by using the following equation: number of extra blocks=number of namespaces −1. For example, if there are four namespaces created initially, the number of extra blocks would be 3. Put another way, an array of blocks 510 could include blocks numbered from 0 to 19, with extra blocks numbered 20 to 22.

A solid-state drive may include a LBA to namespace mapping linked list 512.

Multiple namespaces (514, 516, 518 and 520) may be created and then mapped to the SSD LBA. For example, each namespace 514, 516, 518 and 520 may be created with a LBA range of 2,500. Namespace 514 may be mapped to SSD LBA blocks 0, 1, 2, 3 and 4. Namespace 516 may be mapped to SSD LBA blocks 5, 6, 7, 8 and 9. Namespace 518 may be mapped to SSD LBA blocks 10, 11, 12, 13 and 14. Namespace 520 may be mapped to SSD LBA blocks 15, 16, 17, 18 and 19.

Namespaces 514 and 518 may be deleted. Namespaces 516 and 520 may be kept.

Namespaces may be deleted and re-created continuously with different LBA mapping ranges. For example, namespace 522 may be re-created with an LBA range of 2,500 and mapped to SSD LBA blocks 0, 3, 4, 7, 9, 20 and 21. Namespace 524 may be re-mapped to SSD LBA blocks 5, 6, 10, 11 and 13. Namespace 526 may be re-mapped to SSD LBA blocks 1, 2, 15, 18 and 19.

In one embodiment, overprovisioning block mapping may be used to avoid and/or eliminate the need for fragment management operations. Thus, the fragment management operations required by the conventional process that includes more code execution overhead and complication may be avoided and/or eliminated.

Extra blocks, or spare blocks, are required to make the block mapping process operate smoothly because the granularity of the block and the granularity of the namespace are different. When multiple blocks are allocated for a namespace, the total size of LBA of that block allocation may be equal to or larger than the size of LBA for the associated namespace.

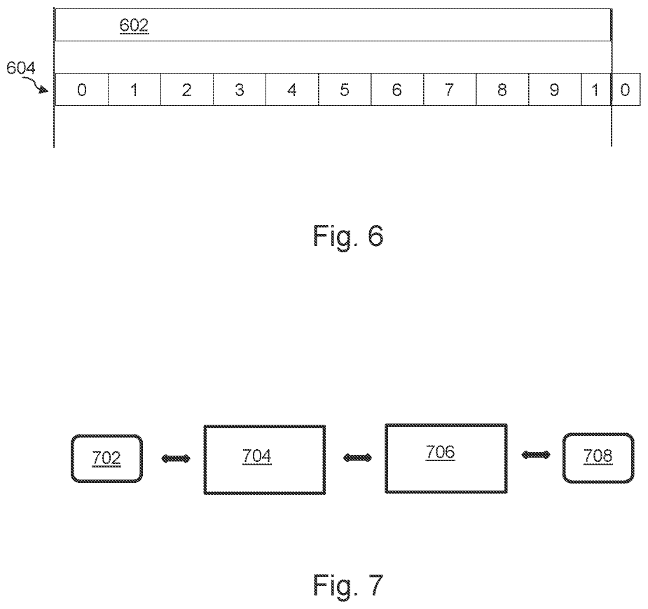

FIG. 6 is a schematic block diagram that illustrates an example of the allocation of blocks for a namespace. A namespace 602 may have an LBA range of 0˜-1,049. The block allocation 604 may include a total number of eleven blocks, which block may be designated as blocks 0 to 10. Each block may have an LBA range of 100. Thus, the LBA range is 0˜1,049 and the block range is 0˜1,100, however, half of the last block is leftover and being wasted. It should be noted that the LBA ranges provided here are for example purposes. In practice, the LBA ranges can vary and be any appropriate amount, i.e, block LBA ranges may be 100, 500, or any suitable range. Also, the portion of the leftover LBA range that is wasted can be controlled by the programmer, and may be any appropriate portion. The leftover LBA of the last allocated block, or leftover portion, can vary from 0˜m−1, where m equals the total LBA size of the last allocated block. Wasting one-half of the LBA range of the last allocated block is an example of a portion that may be leftover and wasted, but any appropriate portion may be designated.

This allocation of extra blocks, including the wasting of half of the last block, makes it so fragment management is not required. Since fragment management is not required, code execution overhead and complicated namespace management is minimized.

The allocation of a predefined number of extra blocks, or spare blocks, is an important step in this process. In this block mapping process, it is important to reserve extra blocks to cover the total LBA range of SSD capacity due to the mismatch in the respective granularities between namespaces and blocks. The predefined number of extra blocks needed to support a maximum number of namespaces may be determined using the following equation: number of extra blocks=maximum number of namespaces −1. Thus, if a SSD supports thirty-two (32) namespaces, the number of extra blocks required will be thirty-one (31).

FIG. 7 is a flow diagram illustrating that the block mapping should be inserted between L2P (Logical LBA to physical NAND memory) mapping and namespaces. Put another way, the block mapping process 704 described herein (i.e., FIGS. 5 and 6) should be inserted between L2P mapping 706 to physical NAND memory 708 and namespace 702.

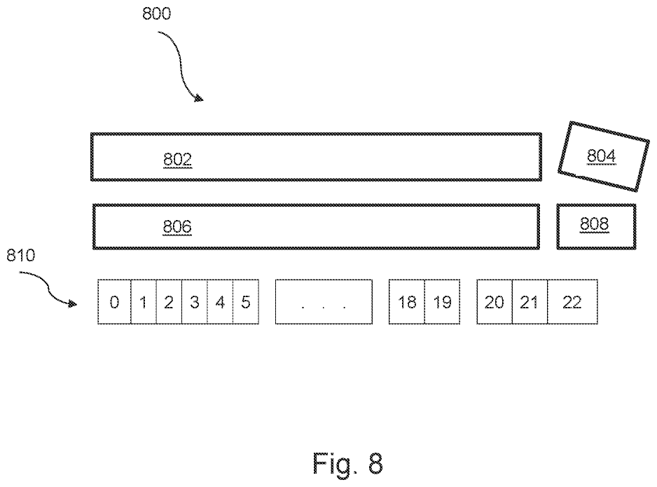

FIG. 8 is a schematic block diagram illustrating a block mapping process 800, in accordance with one embodiment of the invention. A solid-state drive 802 may be described as having a physical capacity and an LBA range, i.e., a capacity range of 0 ˜9,999, which SSD may also include a spare physical capacity 804 having a range of 10,000˜11,499. Similarly, a solid-state drive 806 may be described as having a L2P mapping (Logical Drive LBA to Physical NAND address) LBA range, i.e., an L2P mapping range of 0 ˜ 9,999, which SSD may also include a spare mapping range 808 of 10,000-11,499. The SSD mapping range may also be described as an array of blocks, which blocks may be designated using a numerical range, i.e., 0 to n.

For example, an array of blocks 810 may designated using a numerical range of 0 to 22, which array of blocks may be associated with four namespaces. One block size may have an LBA range of 500. A desired number of extra blocks may be determined by using the following equation: number of extra blocks=number of namespaces −1. For example, if there are four namespaces created initially, the number of extra blocks would be 3. Put another way, an array of blocks 810 could include blocks numbered from 0 to 19, with extra blocks numbered 20 to 22.

However, even though this block mapping process requires more blocks than the actual SSD LBA capacity, it does not require more physical NAND memory. Thus, the spare capacity 804 is not required by this process. This is because the remaining LBA range of the last allocated block for a namespace will not be mapped to a physical NAND address at all.

This process only requires an appropriate number of extra blocks, or spare blocks, and a bigger L2P mapping table. This process may be described as overprovisioning block mapping.

In one embodiment, a controller for a computing device, similar to controller 206, may be programmed to perform overprovisioning block mapping for a namespace. The controller may be programmed to create a namespace, perform block mapping and allocate blocks to the namespace, wherein the allocation of blocks includes an overprovisioning of blocks to the namespace, and thereby minimize the need for defragmentation operations related to the namespace. The controller may be programmed to perform the overprovisioning block mapping between the namespace and logical LBA to physical NAND memory mapping. The controller may be programmed to repeat the process of creating additional namespaces, deleting selected namespaces, re-created namespaces, and performing overprovisioning block mapping and allocating blocks to all the namespaces until the total physical capacity of an associated solid-state drive is completely mapped. Thus, no spare capacity of the solid-state drive is utilized for the overprovisioning block mapping.

In one embodiment, a controller for a computing device, similar to controller 206, may be programmed to perform overprovisioning block mapping for namespaces. The controller may be programmed to create an initial set of namespaces. This initial set of namespaces could be comprised of two or more namespaces. The controller could be programmed to perform block mapping of this initial set of namespaces in order to allocate blocks to each of the individual namespaces in this initial set of namespaces. The controller could be programmed in a manner that the allocation of blocks to the individual namespaces includes an overprovisioning of blocks to each individual namespace. The controller could be programmed to deleted a selected number of namespaces from the initial namespaces, but keep the remaining namespaces from the initial set of namespaces. The controller could be programmed to create a set of new namespaces. The new set of namespaces could be comprised of two or more namespaces, and could include the re-creation of previously deleted namespaces. The controller could be programmed to perform block mapping of the new set of namespaces in order to allocate blocks to each of the individual namespaces in the new set of namespaces. The controller could be programmed in a manner that the allocation of blocks to the individual namespaces includes an overprovisioning of blocks to each individual namespace in the new set of namespaces. The allocation of blocks to namespaces can be consistent with respect to namespaces in the initial set and namespaces in the new set, or the allocation of blocks to individual namespaces can be varied, depending on the desired configuration of the namespaces. This could be described as re-mapping of the blocks in the namespaces.

The controller may be programmed to perform the block mapping between the namespace and logical LBA to physical NAND memory mapping. The controller may be programmed to calculate the number of extra blocks, or spare blocks, needed for overprovisioning block mapping using a formula, i.e., the number of extra blocks to be allocated equals the total number of namespaces minus one. Put another way, the number of extra blocks to be allocated for overprovisioning block mapping equals the total number of namespaces minus one. The controller may be programmed to allow one-half, or any other appropriate leftover portion, of the last block allocated to the individual namespaces to be wasted.

The controller may be programmed to allocate extra blocks for overprovisioning block mapping and utilize the total physical capacity of an associated solid-state drive. The controller may be programmed to reserve extra blocks to cover the total LBA range of the solid-state drive capacity to account for the mismatch in the respective granularities between the namespaces and the blocks.

The controller may be programmed in such a manner that the overprovisioning block mapping mitigates, or eliminates, the need for defragmentation operations with respect to the namespaces. This may also mitigate, or lessen, overhead on the SSD associated with the namespaces.

1. A controller for a computing device, the controller being programmed to:
create a namespace;
perform block mapping and allocate blocks to the namespace, wherein the allocation of blocks includes an overprovisioning of blocks to the namespace; and
minimize the need for defragmentation operations related to the namespace.

2. The controller of claim 1, wherein the controller is further programmed to perform the block mapping between the namespace and logical LBA to physical NAND memory mapping.

3. The controller of claim 2, wherein the controller is further programmed to:
create multiple, additional namespaces;
delete selected namespaces;
create new namespaces;
perform block mapping and allocate blocks to the new namespaces, wherein the allocation of blocks to the new namespaces includes an overprovisioning of blocks to individual namespaces; and
eliminate the need for defragmentation operations related to all the namespaces.

4. The controller of claim 3, wherein the number of blocks included in the overprovisioning is determined in accordance with the formula that the number of extra blocks to be allocated equals the total number of namespaces minus one.

5. The controller of claim 4, wherein the controller is further programmed to allow a leftover portion of the last block allocated to the individual namespaces to be wasted.

6. The controller of claim 5, wherein one block size is 500 LBA.

7. The controller of claim 5, wherein the controller is further programmed to allow re-mapping of the blocks allocated to all of the namespaces.

8. The controller of claim 7, wherein the controller is further programmed to repeat the process of creating additional namespaces, deleting selected namespaces, re-created namespaces, and performing overprovisioning block mapping and allocating blocks to all the namespaces until the total physical capacity of an associated solid-state drive is completely mapped.

9. The controller of claim 8, wherein no spare capacity of the solid-state drive is utilized for the overprovisioning block mapping.

10. A controller for a computing device, the controller being programmed to:
create initial namespaces, wherein at least two initial namespaces are created, and block mapping is performed to allocate blocks to the initial namespaces, wherein the allocation of blocks to the initial namespaces includes an overprovisioning of blocks to the initial namespaces;
delete selected namespaces;
create new namespaces, wherein at least two new namespaces are created, and block mapping is performed to allocate blocks to the new namespaces, wherein the allocation of blocks to the new namespaces includes an overprovisioning of blocks to the new namespaces; and
eliminate the need for defragmentation operations related to all the namespaces.

11. The controller of claim 10, wherein the controller is further programmed to perform the overprovisioning block mapping between the namespace and logical LBA to physical NAND memory mapping and to allocate extra blocks for overprovisioning block mapping and utilize the total physical capacity of an associated solid-state drive.

12. The controller of claim 11, wherein the number of blocks included in the overprovisioning is determined in accordance with the formula: the number of extra blocks to be allocated equals the total number of namespaces minus one.

13. The controller of claim 12, wherein the controller is further programmed to allow re-mapping of the blocks allocated to all of the namespaces.

14. The controller of claim 13, wherein the controller is further programmed to allow a leftover portion of the last block allocated to the individual namespaces to be wasted.

15. A controller for a computing device, the controller being programmed to:
create initial namespaces, wherein at least two initial namespaces are created;
perform block mapping corresponding to a desired LBA range to allocate blocks to the initial namespaces, wherein the allocation of blocks to the initial namespaces includes an overprovisioning of blocks to the initial namespaces;
delete selected namespaces from the initial namespaces;
create new namespaces, wherein at least two new namespaces are created;
perform block mapping corresponding to a desired LBA range is performed to allocate blocks to the new namespaces, wherein the allocation of blocks to the new namespaces includes an overprovisioning of blocks to the new namespaces.

16. The controller of claim 15, wherein the controller is further programmed to perform the overprovisioning block mapping between the namespace and logical LBA to physical NAND memory mapping.

17. The controller of claim 16, wherein the controller is further programmed to allocate extra blocks for overprovisioning block mapping and utilize the total physical capacity of an associated solid-state drive.

18. The controller of claim 17, wherein the number of blocks included in the overprovisioning is determined in accordance with the formula: the number of extra blocks to be allocated equals the total number of namespaces minus one.

19. The controller of claim 18, wherein the need for defragmentation operations related to the namespaces is eliminated.

20. The controller of claim 19, wherein the overhead of the associated solid-state drive is mitigated.
